(19) United States
(12) Patent Application Publication
(10) Pub. No.: US 2010/0047520 A1
(43) Pub. Date: Feb. 25, 2010

(54) PLASTICS COMPOSITE MOULDING WITH A THREE-LAYER STRUCTURE

(75) Inventors: Wolfgang Drube, Odenthal (DE); Jürgen Hãtting, Odenthal (DE); Govert Woeste, Dusseldorf (DE); Werner Aumüller, Unteraltenbernheim (DE); Uwe Stenglin, Adelshofen/Tauberzell (DE)

Correspondence Address: CONNOLLY BOVE LODGE & HUTZ, LLP, P O BOX 2207, WILMINGTON, DE, 19899, US

(73) Assignees: Bayer MaterialScience AG, Leverkusen (DE); PTS Plastic Technologie Service Marketing & Vertriebs GmbH, Adelshofen (DE)

(21) Appl. No.: 12/543,554

(22) Filed: Aug. 19, 2009

(30) Foreign Application Priority Data
Aug. 20, 2008 (DE) 102008038522.0

(51) Int. Cl. B32B 3/00; B32B 27/40; B32B 27/36; B32B 27/28; B32B 27/32; B32B 27/06; B32B 7/12; B32B 3/26; B32B 5/00

(52) U.S. Cl. 428/141; 428/423.1; 428/480; 428/500; 428/521; 428/317.5; 428/474.4; 428/339

(57) ABSTRACT

The invention relates to plastics composite mouldings, in particular for the interior trim of motor vehicles, with a three-layer structure comprising a non-foamed support element and a surface layer with an adhesion-modified functional layer arranged between the support element and surface layer.

### RELATED APPLICATIONS

This application claims benefit to German Patent Application No. 10 2008 038 522.0, filed Aug. 20, 2008, which is incorporated herein by reference in its entirety for all useful purposes.

### BACKGROUND OF THE INVENTION

The invention relates to plastics composite mouldings, in particular for the interior trim of motor vehicles, with a three-layer structure comprising a non-foamed carrier element and a surface layer with an adhesion-modified functional layer arranged between the carrier element and surface layer.

With respect to the technical background, reference is made to DE-A 24 16694, which describes a device for the production of mouldings with a smooth surface and foamed core from thermoplastics containing a blowing agent, comprising two mould halves and a breathing device by means of which the starting or injection volume can be changed. The change or increase in size is generally called “breathing”.

According to DE 24 16694 A 1, for the production of a moulding from a thermoplastic containing a blowing agent the mould is first closed. A given shot volume of a plasticated plastic heated to the foaming temperature is subsequently injected in via a nozzle of an injection moulding machine. During the injection operation a clamping pressure which exceeds the gas pressure of the blowing agent is maintained, so that the plastics composition injected in cannot foam.

After this plastics composition under pressure has cooled on the surface to form a smooth surface layer, the mould halves are moved apart in a defined manner and the volume is thus increased in size. Due to the increase in size, the pressure of the plastics composition injected in is lowered, so that the inner, still warm and fluid plastics composition can expand. The cooled and solidified surface layer holds its position here on the wall of the enlarged mould, and a foamed core forms.

Reference is furthermore made to DEA 43 04 751, which relates to a process for the production of a plastics part, on to which a surface layer of a foamed plastic of a thermoplastic elastomer with an outer skin is applied.

According to DE 43 04 751 A1, for the production of a composite part the plastics part is arranged in an injection mould such that a hollow space remains on the side of the surface layer to be applied. A foamable composition of the thermoplastic elastomer and a blowing agent is subsequently injected into this hollow space, and on foaming of the composition the hollow space increases in size.

The production of plastics composite mouldings which comprise a plastics part with a surface layer of foamed plastic is simplified considerably by the process proposed in DE 43 04 751 A1.

According to EP-B 0 907 484, for production of an injection-moulded part an insert is arranged in a mould cavity and is encapsulated by injection moulding with a layering of at least one hard and thereafter at least one soft component of a plastics material via an injection cylinder. The hard component is said here both to form a relatively hard outer skin generating a dry handle and to ensure adhesion to the insert. On the other hand, the soft component enclosed by the hard component is said to generate a soft handle. These pleasant haptics on pressing, that is to say a desired pliability on pressing, is achieved by a hardness of the soft component of from 7 to 40 Shore A.

The process described in EP-B 0 907 484 for the production of structural parts is a special process of composite injection moulding (multi-component process), so-called sandwich injection moulding. In this, two materials (surface and functional layer) are injected simultaneously into the mould cavity via a gate. The material of the surface layer is initially introduced during the mould filling operation and then forms the so-called skin component, and thereafter the fluid centre thereof is filled with the material of the functional layer (core component). The skin component (surface layer material) is deposited here on the mould wall, so that it reproduces the surface of the structural part. Also before the injection in the sandwich process, the carrier element is positioned beforehand as an insert, and the sandwich then flows over this, so that the skin component thereof the surface layer, bonds with the carrier element to form a closed material. In order to achieve pleasant haptics on pressing with a simultaneous scratch-resistant surface, thermoplastic elastomers with a significantly higher Shore A hardness than that of the functional layer are used for the surface layer.

The process described in EP-B 0 907 484 meets its limits in the production of structural parts injection moulded over their surface. In the injection moulding process for mouldings, as a rule confluences of material, the so-called flow lines, arise when the material flows around recesses/insert parts. In the sandwich process, such flow lines are therefore always composed of the material of the skin component (that is to say the harder surface layer). On the finished structural part, the surfaces in the region of the flow lines show different haptics on pressing, namely a significant increase in the hardness of the layer structure due to the absence of the underlying functional layer (core component).

However, these irregular haptics on pressing are not accepted by the users of the structural parts in practice. Since the sandwich process described in EP-B 0 907 484 fractions according to the displacement principle during the mould filling operation, regions which comprise only surface layer material furthermore are formed at the end of the flow path (structural part boundary). These regions are likewise distinguished by a significantly higher unacceptable hardness, and therefore completely different haptics on pressing, compared with regions towards the centre of the moulding.

It is also disclosed in EP-B 0 907 484 that due to the soft functional layer being enclosed by the hard surface layer, a thin layer of the hard component lies on the inserted carrier. In this way it ensures adhesion there between the carrier on the one hand and the other layers on the other hand, which according to EP-B 0 907 484 would be inadequate between the carrier and soft component. This sequence of the individual layers which is necessary according to EP-B 0 907 484 makes the structural part expensive and susceptible to defects.

DE-A 10 2004 033 139 describes a similar three-layer structure. In this case the soft layer which generates the haptics on pressing is introduced between the surface layer and carrier element in a foam injection moulding process. This component, called the functional layer, is said to have adhesion-modifying properties which are not described in more detail. A soft thermoplastic is mentioned as the material of the functional layer, without a detailed definition with respect to the nature and morphology and the hardness of the thermoplastic material. Soft thermoplastics are as a rule all TPE materials (thermoplastic elastomers), which include materials with a hardness of up to 72 Shore D. Three-layer structural parts can be defined accordingly, comprising carrier element, functional layer and surface layer, it being possible for the last two mentioned to be of the same family of materials and to have the same hardness. If e.g. a layer structure with a surface layer of TPU of hardness 90 Shore A and a functional layer of a soft thermoplastic likewise of TPU of hardness 90 Shore A is generated, because the hardness is the same no pliability under pressure (haptics on pressing) and resilience characteristic can be established.

The production process for a three-layer structure is described in DE-A 10 2005 024 776 and is improved with respect to complexity, avoidance of trimming waste and wall thickness quality.

A similar multi-layer structure is described in DE 34 14 794 C2, a foam body being used as the carrier.

DE-A 10 005 862 claims a process for the production of a two-layer structure of a carrier and a foam. The foam can be an SBS (styrene/butadiene/styrene block copolymer), an SEBS (styrene/ethylene/butylene/styrene block copolymer), a PU (polyurethane), a PP-EPDM (polypropylene/ethylene/propylene/diene monomer block copolymer), a polyester elastomer or a biological base material. To generate better bonding between the carrier and foam, compatibilizers which are not specified in more detail are employed. A decorative material can be applied to the foam.

In U.S. Pat. No. 5,472,782, in which a two-layer structure is claimed, to improve the adhesion of thermoplastic polyurethanes to hard plastics, compounds of SBS (styrene/butadiene/styrene block copolymer) or SIS (styrene/isoprene/styrene block copolymer) and the particular hydrogenated forms thereof with thermoplastic polyurethane are described, the content of thermoplastic polyurethanes being 50 to 97 percent by weight.

There is the need in principle to realize plastics composite mouldings with a three-layer structure in which each layer makes a particular contribution to the properties of the plastics composite moulding.

In particular, it has hitherto been possible to solve the problem of adhesion between the individual materials of the various layers either only by complicated processes or unsatisfactorily. Furthermore, many of the plastics composite mouldings in the multi-layer structure available to date cannot be recycled because of their composition from various classes of material.

The object was therefore to provide a plastics composite moulding with a three-layer structure which is easy to produce to achieve the best possible price/performance ratio, and in which the layers adhere to one another very well and to form a closed material.

It has been possible to achieve this object using a specific adhesion-modified functional layer.

### EMBODIMENTS OF THE INVENTION

An embodiment of the present invention is a three-layer plastics composite moulding comprising a non-foamed carrier element a surface layer, and an adhesion-modified functional layer arranged between said non-foamed carrier element and said surface layer, wherein said adhesion-modified functional layer comprises
a) a thermoplastic elastomer selected from the group consisting of hydrogenated styrene block copolymers (HSBC);
b) a adhesion modifier selected from the group consisting of thermoplastic polyether block amides (TPE-A), thermoplastic polyester elastomers (TPE-E), and thermoplastic polyurethanes (TPU) in an amount of from 60 to 100 parts by weight, based on 100 parts by weight of the sum of elastomer a) and, if present, compatibilizer d);
c) a plasticizer; and
d) optionally a compatibilizer.

Another embodiment of the present invention is the above three-layer plastics composite moulding, wherein said thermoplastic elastomer a) is selected from the group consisting of styrene/ethylene/propylene/styrene block copolymers (SEPS), styrene/ethylene/ethylene/propylene/styrene block copolymers (SEEPS), styrene/ethylene/butylene/styrene block copolymer (SEBS), and combinations thereof.

Another embodiment of the present invention is the above three-layer plastics composite moulding, wherein said compatibilizer d) is selected from the group consisting of styrene/butadiene/styrene block copolymers (SBS), styrene/SBS copolymers, and thermoplastic polymers functionalized by polar grafting.

Another embodiment of the present invention is the above three-layer plastics composite moulding, wherein said thermoplastic polymer functionalized by polar grafting is selected from the group consisting of hydrogenated styrene block copolymers (HSBC), polypropylene (PP), ethylene/propylene/diene monomer block copolymers (EPDM), polyolefins, methacrylate/butadiene/styrene block copolymers (MBS, core-shell modifiers), polystyrenes, and ionomers.

Another embodiment of the present invention is the above three-layer plastics composite moulding, wherein said thermoplastic polymer functionalized by polar grafting is a hydrogenated styrene block copolymer (HSBC) functionalized by polar grafting.

Another embodiment of the present invention is the above three-layer plastics composite moulding, wherein the functionalization of said thermoplastic polymer functionalized by polar grafting is achieved by grafting with organic compounds comprising polar groups.

Another embodiment of the present invention is the above three-layer plastics composite moulding, wherein said compatibilizer d) is preferably present in an amount in the range of from 1 to 100 parts by weight based on 100 parts by weight of the thermoplastic elastomer a) of the functional layer.

Another embodiment of the present invention is the above three-layer plastics composite moulding, wherein said plasticizer c) comprises a paraffinic oil.

Another embodiment of the present invention is the above three-layer plastics composite moulding, wherein said plasticizer c) comprises white mineral oil.

Another embodiment of the present invention is the above three-layer plastics composite moulding, wherein said plasticizer c) is preferably present in an amount in the range of from 1 to 300 parts by weight, based on 100 parts by weight of the sum of elastomer a) and, if present, compatibilizer d).

Another embodiment of the present invention is the above three-layer plastics composite moulding, wherein said adhesion-modified functional layer has a hardness of less than 46 Shore A.

Another embodiment of the present invention is the above three-layer plastics composite moulding, wherein said adhesion-modified functional layer has a wall thickness in the foamed state in the range of from 2 to 15 mm.

Another embodiment of the present invention is the above three-layer plastics composite moulding, wherein said adhesion-modified functional layer is a foamed or non-foamed layer.

Another embodiment of the present invention is the above three-layer plastics composite moulding, wherein said non-foamed carrier element comprises a thermoplastic selected from the group consisting of polyamide (PA), polypropylene (PP), glass fibre-reinforced PP, polyoxymethylene (POM), polyphenylene oxide (PPO), polybutylene terephthalate (PBT), polystyrene (PS), acrylonitrile/butadiene/styrene copolymer (ABS), polycarbonate (PC)/ABS blend, PS/PP blend, styrene/maleic anhydride copolymer (SMA)/ABS blend, ABS/PA blend, PBT/PC blend, and PBT/acrylonitrile/styrene/acrylic ester (ASA) blend.

Another embodiment of the present invention is the above three-layer plastics composite moulding, wherein said surface layer comprises an injection-moulded film or skin or slush skin.

Another embodiment of the present invention is the above three-layer plastics composite moulding, wherein said injection-moulded film comprises plasticized polyvinyl chloride (PVC), a thermoplastic polyether block amide (TPE-A), a thermoplastic polyester elastomer (TPE-E), a thermoplastic polyolefin (TPE-O), or a thermoplastic polyurethane (TPU).

Another embodiment of the present invention is the above three-layer plastics composite moulding, wherein said surface layer has a thickness in the range of from 0.5 to 2 mm.

Another embodiment of the present invention is the above three-layer plastics composite moulding, wherein said surface layer has a grained or structured surface.

Yet another embodiment of the present invention is a dashboard, inner door lining, luggage shelf, handle, operating knob, or screen of a vehicle comprising the above three-layer plastics composite moulding.

### DESCRIPTION OF THE INVENTION

The invention provides a plastics composite moulding which comprises a non-foamed carrier element and a surface layer with an adhesion-modified functional layer arranged between the carrier element and surface layer, which is characterized in that the adhesion-modified functional layer comprises
a) at least one thermoplastic elastomer from the group consisting of hydrogenated styrene block copolymers (HSBC),
b) at least one adhesion modifier from the group consisting of thermoplastic polyether block amides (TPE-A), thermoplastic polyester elastomers (TPE-E) and thermoplastic polyurethanes (TPU) in an amount of from 60 to 100 parts by weight, particularly preferably from 60 to 95 parts by weight, very particularly preferably from 60 to 90 parts by weight, based on 100 parts by weight of the sum of elastomer a) and where appropriate compatibilizer d),
c) at least one plasticizer and
d) optionally a compatibilizer.

With the composition according to the invention of the functional layer, adjustments, in particular of the optical and haptic properties (haptics on pressing), of a particular quality can be achieved with simultaneously very good adhesion between the surface layer and functional layer on the one hand and functional layer and carrier on the other hand, and at low production costs. Furthermore, aspects of the EU end of life vehicles directive 2000/53/EC are met with respect to recyclability of the plastics composite mouldings. The purely thermoplastic three-layer structure can therefore be reused because it can be melted down again.

The non-foamed carrier element can be produced by the injection moulding technique and preferably comprises a thermoplastic from the group of construction materials. Preferred materials are e.g. polyamide (PA), polypropylene (PP)— optionally glass fibre-reinforced—, polyoxymethylene (POM), polyphenylene oxide (PPO), polybutylene terephthalate (PBT), polystyrene (PS), acrylonitrile/butadiene/styrene copolymer (ABS), polycarbonate (PC)/ABS blend, PS/PP blend, SMA(styrene/maleic anhydride copolymer)/ABS blend, ABS/PA blend, PBT/PC blend and PBT/acrylonitrile/styrene/acrylic ester (ASA) blend, and ABS, ABS/PA blend and PC/ABS blend are particularly preferred.

The adhesion-modified functional layer adheres very well cohesively to the carrier elements mentioned when injection moulded over the surface. From the construction aspect, reinforcing ribs can be provided to increase the rigidity of the carrier element.

Films of plastic, in particular decorative films, are preferably used as the surface layer. The surface layer can preferably be grained or structured and has a preferred thickness of from approx. 0.5 to 2 mm. The film can be produced, for example, from plasticized polyvinyl chloride (PVC) or from a thermoplastic elastomer (TPE), such as e.g. a thermoplastic polyether block amide (TPE-A), a thermoplastic polyester elastomer (TPE-E), a thermoplastic polyolefin (TPE-O) or a thermoplastic polyurethane (TPU). In this context, it is preferably a thermoplastic polyurethane, particularly preferably an aliphatic TPU, since the latter is particularly light-stable. TPU furthermore have a very good abrasion resistance and scratch resistance within the thermoplastic elastomers, and are therefore particularly suitable for the surface layer.

Thermoplastic polyurethanes (TPU) are of great industrial importance because of their good elastomer properties and thermoplastic processability and are the suitable partner for finishing the non-polar plastic. An overview of the preparation, properties and uses of TPU is given e.g. in Kunststoff Handbuch [G. Becker, D. Braun], volume 7 “Polyurethane”, Munich, Vienna, Carl Hanser Verlag, 1983.

All TPU can be employed in principle for the production of the three-layer structure according to the invention. TPU which are prepared using the following base units are particularly preferred: hexamethylene-diisocyanate, 4,4′-diphenylmethane-diisocyanate, polyester polyol, polyether polyol, 1,4-butanediol and 1,6-hexanediol.

For surface layers with low exposure to UV or in dark colours, in addition to aliphatic TPU aromatic TPU or polyester elastomer (TPE-E) or blends of TPU and another thermoplastic elastomer can also be used.

The films preferably employed as the surface layer can be produced in slush technology or by means of the injection moulding technique in a compact or foam injection moulding process. They are preferably injection-moulded films, since a surface with non-visible flow lines can be achieved in this case, especially with TPU.

The films of TPU are preferably employed without surface treatment and without surface coating. If the requirement for abrasion and scratch resistance is very high, the films can additionally be subjected to a surface treatment or coating. The films can furthermore have a grained or structured surface.

The adhesion-modified functional layer preferably has a low hardness of less than 46 Shore A, particularly preferably less than 41 Shore A. It comprises a) a thermoplastic elastomer from the group consisting of hydrogenated styrene block copolymers (HSBC), such as e.g. styrene/ethylene/propylene/styrene block copolymer (SEPS), styrene/ethylene/ethylene/propylene/styrene block copolymer (SEEPS) and styrene/ethylene/butylene/styrene block copolymer (SEBS) and combinations of these. In addition, the functional layer comprises as the adhesion modifier b) a polymer from the group consisting of thermoplastic polyether block amides (TPE-A), thermoplastic polyester elastomers (TPE-E) and thermoplastic polyurethanes (TPU), as described e.g. above. The functional layer furthermore comprises a plasticizer c), preferably paraffinic oil, particularly preferably so-called white mineral oil, and optionally a compatibilizer d) from the group consisting of SBS, styrene/SBS copolymers (e.g. Styroflex® from BASF SE) and thermoplastic polymers functionalized by polar grafting. The functional layer can be in a foamed or non-foamed form.

When injection moulded behind the surface layer, e.g. an injection-moulded film or skin or a slush skin, the adhesion-modified functional layer shows a good adhesion to the surface layer, so that a cohesive composite can be produced by injection moulding.

Thermoplastic polyurethane (TPU), as described above, is preferably employed as the adhesion modifier b) in the functional layer. Preferably, this adhesion modifier is present in an amount of from 60 to 100 parts by weight, particularly preferably from 60 to 95 parts by weight, very particularly preferably from 60 to 90 parts by weight, based on 100 parts by weight of the thermoplastic elastomer a) and of the compatibilizer d), if present, of the functional layer.

In a particularly preferred embodiment, the functional layer comprises a compatibilizer.

Compatibilizers between the thermoplastic elastomer and the adhesion modifier which can be employed are SBS, styrene/SBS copolymer (e.g. Styroflex® from BASF SE) or a thermoplastic polymer which has been functionalized by polar grafting, such as e.g. hydrogenated styrene block copolymers (HSBC), polypropylene (PP), ethylene/propylene/diene monomer block copolymer (EPDM), polyolefin, methacrylate/butadiene/styrene block copolymer (MBS, core-shell modifier), polystyrene, and/or ionomer (e.g. Surlyn® from DuPont). The functionalization of the thermoplastic polymers mentioned is achieved e.g. by grafting with organic compounds which contain polar groups, such as e.g. anhydrides (e.g. maleic anhydride (MA)), acrylates, epoxides and/or acid groups. Preferably, one of the abovementioned thermoplastic polymers grafted with polar groups is employed as the compatibilizer, particularly preferably functionalized HSBC. Preferably, the compatibilizer is present in an amount of from 0 to 100 parts by weight, preferably from 1 to 100 parts by weight, based on 100 parts by weight of the thermoplastic elastomer a) of the functional layer.

Preferably, paraffinic oil is employed as the plasticizer, particularly preferably so-called white mineral oil. This is preferably present in an amount of from 1 to 300 parts by weight, based on 100 parts by weight of the thermoplastic elastomer a) of the functional layer and of the compatibilizer d), if present.

The adhesion-modified functional layer has a preferred wall thickness of a few millimetres, in particular of from approx. 2 to 15 mm, and comprises the constituents described above. The functional layer can be foamed by chemical or physical blowing agents or a combination of both and can then be formed as a foam layer e.g. in a mould breathing process.

The plastics composite moulding is produced in an injection mould which comprises two mould halves enclosing a mould cavity, and optionally slides.

The plastics composite moulding can preferably be produced by first producing the carrier element and the surface layer separately in an injection moulding process. The carrier element produced in this way and the surface layer produced in this way are then laid in an injection mould such that a hollow space remains between them, into which the functional layer is then introduced in a further injection moulding process step.

A foam structure in the functional layer is advantageous for achieving soft haptics on pressing. This foam structure is achieved by the known TFC process (TFC=thermoplastic foam casting according to Saechtling, Kunststofftaschenbuch, 30th edition) in combination with mould breathing during the injection moulding processing. The foam structure is preferably achieved by physical blowing agents based on microspheres (=hollow beads which expand under the action of heat, such as e.g. THERMOCEL-Master 180/65 from Plastic Technologie Service). These are admixed before the injection moulding in a dosage of from preferably 2 to 6 wt. %, based on the weight of the functional layer.

By the mould breathing process (opening of the cavity after the injection by a defined foam lift), the microsphere blowing agent can achieve its optimum action in the functional layer and produce a fine-celled foam structure.

The plastics composite mouldings according to the invention are distinguished by pleasant haptics on pressing, that is to say a soft compressibility of the moulding surface and good wear resistance.

In the production of the plastics composite mouldings according to the invention, no after-working, such as e.g. cutting out or stamping out of openings (such as e.g. for radio compartments, ventilator nozzles in an instrument panel) or removal of flashes, is necessary. After-treatment of the surface of the plastics composite mouldings in order to make these abrasion- and scratch-resistant is also not necessary. The process described renders possible a high degree of integration of functions and a reduction in production costs.

The plastics composite mouldings are preferably employed inside vehicles, e.g. as a dashboard, inner door lining, luggage shelf, handle, operating knob, screen or the like.

The invention is to be explained in more detail with the aid of the following examples.

All the references described above are incorporated by reference in their entireties for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

### EXAMPLES

The PC+ABS blends mentioned, with the trade name BAYBLEND® T85, and the TPU Desmopan® DP85092A are commercial products of Bayer MaterialScience AG (Leverkusen, Germany).

The materials of the functional layer were prepared in a mixing process under the action of heat in a twin screw kneader (TSE, twin-screw extruder) conventionally used for compounding plastics. A premix of the raw materials corresponding to the recipe structure (cf. Table 1) was fed to the twin-screw extruder via a metering device and plasticated and homogenized under heat (from 140° C. to 250° C.) and the action of shearing forces. On leaving the twin-screw extruder, the plasticated plastics composition was passed through a perforated plate and over a water granulating device, so that the material of the functional layer was in the form of granules.

TABLE 1
Description of the materials in the functional layer

| | | Hardness |
|---|---|---|
| Functional layer | Recipe structure | [shore A] |
| Polymer granules 1 | 25 phr SEEPS/30% styrene content a) | 34 |
| | 50 phr SEPS/10% styrene content a) | |
| | 25 phr SEBS-MA d) | |
| | 60 phr paraffin oil c) | |
| | 32.5 phr ether-based TPU Shore A | |
| | 70 b) | |
| | 17.5 phr ester-based TPU Shore A 86 b) | |
| Polymer granules 2 | 25 phr SEEPS/30% styrene content | 35 |
| | 50 phr SEPS/10% styrene content | |
| | 25 phr SEBS-MA | |
| | 60 phr paraffin oil | |
| | 45.5 phr ether-based TPU Shore A 70 | |
| | 24.5 phr ester-based TPU Shore A 86 | |
| Polymer granules 3 | 25 phr SEEPS/30% styrene content | 38 |
| | 50 phr SEPS/10% styrene content | |
| | 25 phr SEBS-MA | |
| | 60 phr paraffin oil | |
| | 52 phr ether-based TPU Shore A 70 | |
| | 28 phr ester-based TPU Shore A 86 | |
| Polymer granules 4 | 25 phr SEEPS/30% styrene content | 40 |
| | 50 phr SEPS/10% styrene content | |
| | 25 phr SEBS-MA | |
| | 60 phr paraffin oil | |
| | 65 phr ether-based TPU Shore A 70 | |
| | 34 phr ester-based TPU Shore A 86 | |
| Polymer granules 5 | 25 phr SEEPS/30% styrene content | 48 |
| | 50 phr SEPS/10% styrene content | |
| | 25 phr SEBS-MA | |
| | 60 phr paraffin oil | |
| | 110.5 phr ether-based TPU Shore A 70 | |
| | 59.5 phr ester-based TPU Shore A 86 | |

The Shore hardnesses were determined in accordance with ISO 868.
“phr” means “parts per hundred”;
parts means parts by weight

The three-layer structure was produced by injection moulding processes following successively in time. The layers of carrier element and surface layer produced in separate injection moulding processes were first laid into an injection mould such that a hollow space remained between them. The functional layer was then introduced into this hollow space through one or more openings or breakthroughs provided in the carrier element in a further injection moulding process step. That is to say, the hollow space between the surface layer and carrier element was filled completely with functional layer by injection.

To achieve soft haptics on pressing, a foam structure was produced in the functional layer by the known TFC process (TFC=thermoplastic foam casting according to Saechtling, Kunststofftaschenbuch, 30th edition) in combination with mould breathing. In this procedure, on injection of the functional layer into the mould cavity between the carrier element and surface layer, this was first filled with the material of the functional layer volumetrically and without follow-up pressure. Immediately after the end of the injection pressure and reaching of volumetric filling, for this a defined foaming lift of approx. 20 to 50% of the original mould cavity thickness was generated via a core puller or slide with the aid of vertical flash faces with the mould closed, so that the physical blowing agent THERMOCEL-Master 180/65 from Plastic Technologie Service added beforehand in the hopper of the injection moulding machine in an amount of from 4 to 6 wt. %, based on the weight of the functional layer, expanded against atmospheric pressure. This blowing agent consists of so-called microspheres, i.e. gas bubbles which are enclosed by a shell of plastic and expand to a defined degree in the polymer melt under the action of heat.

Since for practical reasons no adhesion measurements can be carried out on the finished three-layer structure between the surface layer and functional layer on the one hand and between the functional layer and carrier element on the other hand, in each case test specimen constructed from only two layers were produced for the adhesion measurements.

### Measurement Methods for Determination of the Bond Strength Between the Hard and Soft Component

Basic testing of the bond strength between the 1st component (carrier element or surface layer) and soft component (functional layer) is carried out in accordance with a standardized test method, the roller peel test according to DIN EN 1464. This test method describes the “Determination of peel resistance of high-strength adhesive bonds” and relates to adhesive bonds with metal. Because of the dimensions of the test specimen, the roller peel testing device described in DIN EN 1464, which is incorporated into a tensile tester, was modified slightly in its roller length (lengthening to 103 mm) in order to position the test specimen. The test specimen geometry specified in the standard likewise was not used. The deviation of the composite test specimen from the standard test specimen comprises a somewhat different geometry and a shorter joining zone between the two components. Since the measurements are relative comparative measurements, the deviations of the test specimens from the standard are of no significance for the evaluation. The soft component is peeled off in accordance with DIN EN 1464 at an angle of 90° to the composite surface.

The test specimen in the present tests is constructed from a frame comprising the surface layer or carrier layer (1st component) with external dimensions of 130×100×3 mm. The width of the frame is 25 mm on three sides and 45 mm on the fourth side. The material of the functional layer (soft component or 2nd component) is injection moulded over the surface of the frame on this wider side over an area of 45 mm×35 mm. The soft component is a lip with a wall thickness of 2 mm, a length of 115 mm and a width of 35 mm. The central gating of the soft component is through a bore in the material of the 1st component. Symmetric flow paths result. The test specimen is produced with a 2-component mould by the core retraction process, in order to create good conditions for the bond strength. Reference is made to DE-A 10 2004 047 200 for further details.

The test specimens were produced in accordance with the parameters given in Table 2 on a multi-component injection moulding machine with a clamping force of 1,000 kN (Arburg Allrounder, 420 V 1000-350/150 model, manufacturer Arburg, D72290 Loβburg).

The characteristic value for the bond strength from the 90° roller peel test according to DIN EN 1464 is stated as the peel resistance in the unit of [N/mm]:
Peel resistance [N/mm]=Peel force [N]/Specimen width [mm]

The values of the minimum peel force Fmin, the maximum peel force Fmax and the average peel force Faverage are measured.

The average peel force is shown in Tables 3a and 3b and is a measure for evaluation of the bond strength. The average peel resistance is calculated by dividing the value of the average peel force by the width of the soft component (35 mm).

TABLE 2
Injection moulding parameters for production of the test specimens

| Material of 1st component: | Material of soft component: |
|---|---|
| BAYBLEND ® T85 (PC + ABS) | Polymer granules 1 |
| ″ | Polymer granules 2 |
| ″ | Polymer granules 3 |
| ″ | Polymer granules 4 |
| ″ | Polymer granules 5 |
| Pre-drying temperature: 80 [° C.] | Pre-drying temperature: 80 [° C.] |
| Pre-drying time: 3 [h] | Pre-drying time: 2 [h] |
| Mould temperature: 70 [° C.] | Mould temperature: 20 [° C.] |
| Heating zone 5 (nozzle): 270 [° C.] | Hot runner manifold: 180 [° C.] |
| Heating zone 4: 260 [° C.] | Hot runner cartridge: 180 [° C.] |
| Heating zone 3: 260 [° C.] | Heating zone 5 (nozzle): 190 [° C.] |
| | Heating zone 4: 180 [° C.] |
| | Heating zone 3: 170 [° C.] |
| Heating zone 2: 250 [° C.] | Heating zone 2: 160 [° C.] |
| Heating zone 1 (hopper): 230 [° C.] | Heating zone 1 (hopper): 150 [° C.] |
| Injection pressure: 1000-1500 [bar] | Injection pressure: 350-600 [bar] |
| Injection speed: 40-60 [cm³/s] | Injection speed 50-100 [cm³/s] |
| Injection time (actual value): 1.7-2.1 [s] | Injection time (actual value): 0.3-1.0[s] |
| Changeover point: 4-6 [cm³] | Changeover point: 2-6 [cm³] |
| Follow-up pressure 1: 900 [bar] | Follow-up pressure 1: 0-600 [bar] |
| Follow-up pressure time 1: 3-5 [s] | Follow-up pressure time 1: 0-4 [s] |
| Residual cooling time: 6-10 [s] | Residual cooling time: 15-35 [s] |
| Back pressure: 70 [bar] | Back pressure: 20 [bar] |
| Decompression: 4 [cm³] | Decompression: 2 [cm³] |
| Screw speed: 25 [min⁻¹] | Screw speed: 15 [min⁻¹] |
| Desmopan ® DP85092A | Polymer granules 1 |
| ″ | Polymer granules 2 |
| ″ | Polymer granules 3 |
| ″ | Polymer granules 4 |
| ″ | Polymer granules 5 |
| Pre-drying temperature: 80 [° C.] | Pre-drying temperature: 80 [° C.] |
| Pre-drying temperature: 4 [h] | Pre-drying temperature: 2 [h] |
| Mould temperature: 20 [° C.] | Mould temperature: 20 [° C.] |
| Heating zone 5 (nozzle): 210 [° C.] | Hot runner manifold: 180 [° C.] |
| Heating zone 4: 220 [° C.] | Hot runner cartridge: 180 [° C.] |
| Heating zone 3: 210 [° C.] | Heating zone 5 (nozzle): 190 [° C.] |
| | Heating zone 4: 180 [° C.] |
| | Heating zone 3: 170 [° C.] |
| Heating zone 2: 200 [° C.] | Heating zone 2: 160 [° C.] |
| Heating zone 1 (hopper): 190 [° C.] | Heating zone 1 (hopper): 150 [° C.] |
| Injection pressure: 1300 [bar] | Injection pressure: 350-600 [bar] |
| Injection speed: 70 [cm³/s] | Injection speed: 50-100[cm³/s] |
| Injection time (actual value): 1.5 [s] | Injection, time (actual value): 0.3-1.0 [s] |
| Changeover point: 8 [cm³] | Changeover point: 2-6 [cm³] |
| Follow-up pressure 1: 900 [bar] | Follow-up pressure 1: 0-600 [bar] |
| Follow-up pressure time 1: 6 | Follow-up pressure time 1: 0-4 [s] |
| [s] | |
| Residual cooling time: 24 [s] | Residual cooling time: 15-35 [s] |
| Back pressure: 50 [bar] | Back pressure: 20 [bar] |
| Decompression: 4 [cm³] | Decompression: 2 [cm³] |
| Screw speed: 25 [min⁻¹] | Screw speed: 15 [min⁻¹] |

TABLE 3a
Adhesion investigations carrier/functional layer

| | | Peel | Peel | |
|---|---|---|---|---|
| Carrier layer | Functional layer | force | resistance | Adhesion |
| (1st component): | (2nd component): | [N] | [N/mm] | factor |
| BAYBLEND ® T85 | from polymer | 0 | 0 | 1 |
| (PC + ABS) | granules 1 | | | |
| BAYBLEND ® T85 | from polymer | 72 | 2.0 | 4 |
| (PC + ABS) | granules 2 | | | |
| BAYBLEND ® T85 | from polymer | 74 | 2.0 | 4 |
| (PC + ABS) | granules 3 | | | |
| BAYBLEND ® T85 | from polymer | 72 | 2.0 | 4 |
| (PC + ABS) | granules 4 | | | |
| BAYBLEND ® T85 | from polymer | 104 | 3.0 | 5 |
| (PC + ABS) | granules 5 | | | |

Examples 1 and 5 are comparison examples.

TABLE 3b
Adhesion investigations surface layer/functional layer

| | | Peel | Peel | Ad- |
|---|---|---|---|---|
| Surface layer | Functional layer | force | resistance | hesion |
| (1st component) | (2nd component): | [N] | [N/mm] | factor |
| DESMOPAN ® | from polymer granules 1 | 23 | 0.5 | 2 |
| DP85092A | | | | |
| DESMOPAN ® | from polymer granules 2 | 45 | 1.0 | 3 |
| DP85092A | | | | |
| DESMOPAN ® | from polymer granules 3 | 72 | 2.0 | 4 |
| DP85092A | | | | |
| DESMOPAN ® | from polymer granules 4 | 93 | 3.0 | 5 |
| DP85092A | | | | |
| DESMOPAN ® | from polymer granules 5 | 125 | 4.0 | 5 |
| DP85092A | | | | |

Examples 1 and 5 are comparison examples.

The entries for the adhesion factor mean:

| | | |
|---|---|---|
| 1 | no bonding | no adhesion, no removal from the mould as a |
| | | composite part |
| 2 | adhesion | slight adhesion, soft component does not |
| | | remain bonded to the hard component |
| 3 | adhesion-cohesion | good adhesion, soft component bonds firmly |
| | | with the hard component (cohesion) with gaps |
| 4 | cohesion | very good adhesion, soft component bonds |
| | | firmly with the hard component over the entire |
| | | area, peel fracture within the soft component |
| 5 | cohesion > material | bond strength is higher than the material |
| | strength (C > MS) | strength, inseparable bond, peeling no longer |
| | | possible, soft component tears off before |
| | | peeling starts |

As can be seen from Tables 3a and 3b, it was possible to show with the aid of Examples 2 to 4 that if the individual components of the functional layer are chosen correctly, structural parts with good adhesion of the individual layers to one another and with simultaneously a hardness necessary for good haptics on pressing can be realized.

1. A three-layer plastics composite moulding comprising a non-foamed carrier element, a surface layer, and an adhesion-modified functional layer arranged between said non-foamed carrier element and said surface layer, wherein said adhesion-modified functional layer comprises
a) a thermoplastic elastomer selected from the group consisting of hydrogenated styrene block copolymers (HSBC);
b) a adhesion modifier selected from the group consisting of thermoplastic polyether block amides (TPE-A), thermoplastic polyester elastomers (TPE-E), and thermoplastic polyurethanes (TPU) in an amount of from 60 to 100 parts by weight, based on 100 parts by weight of the sum of elastomer a) and, if present, compatibilizer d);
c) a plasticizer; and
d) optionally a compatibilizer.

2. The three-layer plastics composite moulding of claim 1, wherein said thermoplastic elastomer a) is selected from the group consisting of styrene/ethylene/propylene/styrene block copolymers (SEPS), styrene/ethylene/ethylene/propylene/styrene block copolymers (SEEPS), styrene/ethylene/butylene/styrene block copolymer (SEBS), and combinations thereof.

3. The three-layer plastics composite moulding of claim 1, wherein said compatibilizer d) is selected from the group consisting of styrene/butadiene/styrene block copolymers (SBS), styrene/SBS copolymers, and thermoplastic polymers functionalized by polar grafting.

4. The three-layer plastics composite moulding of claim 3, wherein said thermoplastic polymer functionalized by polar grafting is selected from the group consisting of hydrogenated styrene block copolymers (HSBC), polypropylene (PP), ethylene/propylene/diene monomer block copolymers (EPDM), polyolefins, methacrylate/butadiene/styrene block copolymers (MBS, core-shell modifiers), polystyrenes, and ionomers.

5. The three-layer plastics composite moulding of claim 3, wherein said thermoplastic polymer functionalized by polar grafting is a hydrogenated styrene block copolymer (HSBC) functionalized by polar grafting.

6. The three-layer plastics composite moulding of claim 3, wherein the functionalization of said thermoplastic polymer functionalized by polar grafting is achieved by grafting with organic compounds comprising polar groups.

7. The three-layer plastics composite moulding of claim 1, wherein said compatibilizer d) is present in an amount in the range of from 1 to 100 parts by weight, based on 100 parts by weight of the thermoplastic elastomer a) of the functional layer.

8. The three-layer plastics composite moulding of claim 1, wherein said plasticizer c) comprises a paraffinic oil.

9. The three-layer plastics composite moulding of claim 1, wherein said plasticizer c) comprises white mineral oil.

10. The three-layer plastics composite moulding of claim 1, wherein said plasticizer c) is present in an amount in the range of from 1 to 300 parts by weight, based on 100 parts by weight of the sum of elastomer a) and, if present, compatibilizer d).

11. The three-layer plastics composite moulding of claim 1, wherein said adhesion-modified functional layer has a hardness of less than 46 Shore A.

12. The three-layer plastics composite moulding of claim 1, wherein said adhesion-modified functional layer has a wall thickness in the foamed state in the range of from 2 to 15 mm.

13. The three-layer plastics composite moulding of claim 1, wherein said adhesion-modified functional layer is a foamed or non-foamed layer.

14. The three-layer plastics composite moulding of claim 1, wherein said non-foamed carrier element comprises a thermoplastic selected from the group consisting of polyamide (PA), polypropylene (PP), glass fibre-reinforced PP, polyoxymethylene (POM), polyphenylene oxide (PPO), polybutylene terephthalate (PBT), polystyrene (PS), acrylonitrile/butadiene/styrene copolymer (ABS), polycarbonate (PC)/ABS blend, PS/PP blend, styrene/maleic anhydride copolymer (SMA)/ABS blend, ABS/PA blend, PBT/PC blend, and PBT/acrylonitrile/styrene/acrylic ester (ASA) blend.

15. The three-layer plastics composite moulding of claim 1, wherein said surface layer comprises an injection-moulded film or skin or slush skin.

16. The three-layer plastics composite moulding of claim 15, wherein said injection-moulded film comprises plasticized polyvinyl chloride (PVC), a thermoplastic polyether block amide (TPE-A), a thermoplastic polyester elastomer (TPE-E), a thermoplastic polyolefin (TPE-O), or a thermoplastic polyurethane (TPU).

17. The three-layer plastics composite moulding of claim 1, wherein said surface layer has a thickness in the range of from 0.5 to 2 mm.

18. The three-layer plastics composite moulding of claim 1, wherein said surface layer has a grained or structured surface.

19. A dashboard, inner door lining, luggage shelf, handle, operating knob, or screen of a vehicle comprising the three-layer plastics composite moulding of claim 1.
